(19) United States
(12) Patent Application Publication
(10) Pub. No.: US 2024/0307770 A1
(43) Pub. Date: Sep. 19, 2024

(54) SYSTEM AND METHOD FOR PROVIDING GAME WINS AND LOSSES

(71) Applicant: Volcano Driver Inc., Las Vegas, NV (US)

(72) Inventor: Ki Young NAM, Seongnam-si (KR)

(21) Appl. No.: 18/571,814

(22) PCT Filed: Jun. 20, 2022
(86) PCT No.: PCT/KR2022/008728

§ 371 Date: Dec. 19, 2023

(30) Foreign Application Priority Data
Jun. 21, 2021 (KR) 10-2021-0080247
Jun. 20, 2022 (KR) 10-2022-0074822

(51) Int. Cl. A63F 13/46; A63F 13/35; A63F 13/795

(52) U.S. Cl. CPC A63F 13/46; A63F 13/35; A63F 13/795

(57) ABSTRACT

A system and method for providing game wins and losses are provided.

The system for providing game wins and losses may include a user input (UI) broker module configured to control an input of a player for a game instance, analyze play content for the game instance, and interacting with the player; and a UI broker server configured to provide wins and losses of the player based on analysis of the UI broker module.

### TECHNICAL FIELD

The disclosure relates to a system and method for providing game wins and losses.

### BACKGROUND ART

To increase game immersion and interest of game players, player matching or competition function is used to encourage competition between players. For example, competition between players may be encouraged by matching players playing the game to determine whether players win or lose, or by comparing scores to determine rankings and accordingly rewarding players. However, unlike cases where player matching or competition function is designed or implemented from a development stage, interest in services that provide competition between players is increasing even in games that do not include player matching or competition function.

### DISCLOSURE

### Technical Problem

The present disclosure attempts to provide a system and method for providing game wins and losses capable of providing competition between players regardless of the presence or absence of player matching or competition function.

### Technical Solution

A system for providing game wins and losses according to an embodiment may include a user input (UI) broker module configured to control an input of a player for a game instance, analyze play content for the game instance, and interacting with the player; and a UI broker server configured to provide wins and losses of the player based on analysis of the UI broker module.

In some embodiments, the UI broker module may include a UI broker module configured to control a game progress by intervening in the input of the player.

In some embodiments, the UI broker module may include a video stream analysis module configured to extract wins and losses decision data by analyzing a video stream including the play content, and transmit the wins and losses decision data to the UI broker server.

In some embodiments, the UI broker server may determine wins and losses of the player based on the wins and losses decision data received from the UI broker module and provide the wins and losses to the UI broker module as wins and losses data, and the UI broker module may perform interaction with the player based on the wins and losses data.

In some embodiments, the UI broker module may include a play data collection module configured to collect raw data about the input of the player and the play content.

In some embodiments, the UI broker server may generate a preset including information about a game configuration of the game instance from the collected raw data.

In some embodiments, the UI broker server may perform simulation analysis based on the preset and verify the preset according to the analysis.

In some embodiments, the UI broker module may include a preset providing module configured to provide a preset including information about the game configuration of the game instance.

In some embodiments, the system for providing game wins and losses may further include a game streaming server configured to provide game streaming to a player terminal, and the UI broker module may be included in the game streaming server.

In some embodiments, the system for providing game wins and losses may further include a player terminal, and the UI broker module may be included in the player terminal.

A method for providing game wins and losses according to an embodiment may include generating a preset including information about a game configuration of a game instance; obtaining play data including an input of a player and play content for the game instance in real time; extracting wins and losses decision data by analyzing the play data obtained in real time; generating wins and losses data that decides the wins and losses of the player based on the wins and losses decision data and the preset; and providing the wins and losses of the player based on the wins and losses data and performing interaction with the player.

In some embodiments, the extracting of the wins and losses decision data may include extracting the wins and losses decision data by analyzing a video stream including the play content.

In some embodiments, the generating of the preset may include collecting raw data about the input of the player and the play content; and generating the preset from the raw data.

In some embodiments, the method for providing game wins and losses may further include performing a simulation analysis based on the preset and verifying the preset according to the analysis.

A computer-readable medium according to an embodiment may record a program on a computer for executing generating a preset including information about a game configuration of a game instance; obtaining play data including an input of a player and play content for the game instance in real time; extracting wins and losses decision data by analyzing the play data obtained in real time; generating wins and losses data that decides the wins and losses of the player based on the wins and losses decision data and the preset; and providing the wins and losses of the player based on the wins and losses data and performing interaction with the player.

### DESCRIPTION OF THE DRAWINGS

FIG. 1 is a block diagram for explaining a system for providing game wins and losses according to an embodiment.

FIG. 2 is a block diagram for explaining a game streaming server according to an embodiment.

FIG. 3 is a block diagram for explaining a user input (UI) broker module according to an embodiment.

FIG. 4 is a block diagram for explaining a system for providing game wins and losses according to an embodiment.

FIG. 5 is a flowchart for explaining a method for providing game wins and losses according to an embodiment.

FIGS. 6 to 8 are diagrams showing implementation examples of a system for providing game wins and losses according to an embodiment.

FIG. 9 is a block diagram illustrating a computing device for implementing a system and method for providing game wins and losses according to embodiments.

### MODE FOR INVENTION

With reference to the attached drawings, embodiments of the present invention will be described in detail below so that ordinary skilled in the art may easily implement the present invention. However, the present invention may be implemented in many different forms and is not limited to the embodiments described herein. In order to clearly explain the present invention in the drawings, parts irrelevant to the description are omitted, and like reference numerals designate like elements throughout the specification.

Throughout the specification and the claims, unless explicitly described to the contrary, the word “comprise”, and variations such as “comprises” or “comprising”, may be understood to imply the inclusion of stated elements but not the exclusion of any other elements.

The terms such as “-portion”, “-group”, “module”, and “means” described in the specification may mean a unit that processes at least one function or operation described in the specification, which may be implemented as hardware or software or a combination of hardware and software.

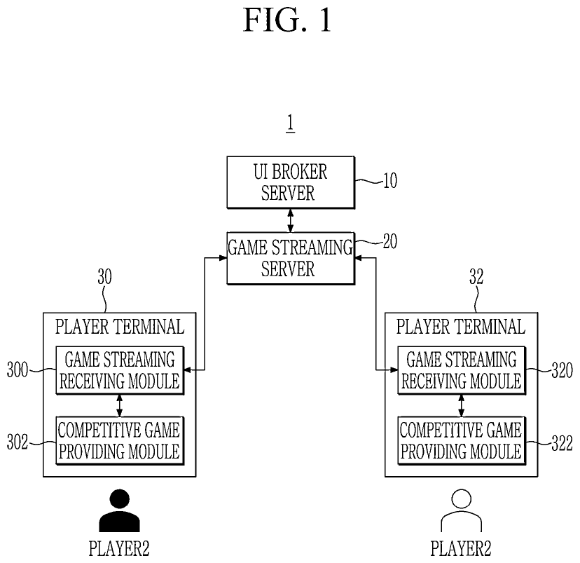

FIG. 1 is a block diagram for explaining a system for providing game wins and losses according to an embodiment.

Referring to FIG. 1, a system 1 for providing game wins and losses according to an embodiment may include a user input (UI) broker server 10, a game streaming server 20, and a plurality of player terminals 30 and 32. In the present embodiment, the distinction between the UI broker server 10 and the game streaming server 20 is logical, and may be implemented as separate servers or integrated into one server according to an actual implementation environment or implementation purpose.

The game streaming server 20 may provide game streaming to the plurality of player terminals 30 and 32 by using game streaming technology. The game streaming technology may stream game instances from a game cloud or a game source device to a user (i.e. player) device, transmit a UI received from the user device during a game play to the game cloud or the game source device, and provide a game, which may enable to enjoy a game without having to install a game application in the user device. For example, when the user device is a smartphone equipped with a touch screen, the game play may be possible by displaying a game instance streaming from the game cloud on the touch screen and transmitting a gesture that a user inputs through the touch screen to the game cloud without having to install a separate game application in the smartphone.

That is, the plurality of player terminals 30 and 32 may provide game streaming received from the game streaming server 20 to players player 1 and player 2 even though the game application is not installed therein, and the game streaming server 20 may be implemented as a cloud server. In some embodiments, the game streaming server 20 may implement game streaming by using WebRTC, but the scope of the present invention is not limited thereto.

The game streaming server 20 may create a plurality of game instances for the same game and provide each of the plurality of game instances to each player. For example, when there are two players, the game streaming server 20 may create a first game instance to be provided to a first player player1 and a second game instance to be provided to a second player player2. The first game instance may be streamed to the player terminal 30 and the second game instance may be streamed to the player terminal 32.

In some embodiments, the game streaming server 20 may additionally create competitive streaming content. The competitive streaming content may include a play image of a competitor or a play image of an arbitrary another player. For example, when streaming the first game instance to the player terminal 30, the game streaming server 20 may stream a play image of the second player player2 who is a competitor of the first player player1 together to the player terminal 30.

The player terminal 30 may include a game streaming receiving module 300 and a competitive game providing module 302. The game streaming receiving module 300 may receive streaming for the first game instance provided from the game streaming server 20, and the competitive game providing module 302 may provide the received game streaming, that is, a competitive game, to the first player player1. That is, the first game instance streamed from the game streaming server 20 may be a game instance implemented by the interface broker server 10 to enable competition between players.

Likewise, the player terminal 32 may include a game streaming receiving module 320 and a competitive game providing module 322, the game streaming receiving module 320 may receive streaming for the second game instance provided from the game streaming server 20, and the competitive game providing module 322 may provide the received game streaming, that is, a competitive game, to the second player player2. That is, the second game instance streaming from the game streaming server 20 may be a game instance implemented by the UI broker server 10 to enable competition between players.

The UI broker server 10 may provide wins and losses of the first player player1 and the second player player2 with respect to the game streaming provided from the game streaming server 20 to the plurality of player terminals 30 and 32. In particular, the UI broker server 10 may provide competition between players and wins and losses not only for games in which player matching or competition function has been designed or implemented from a development stage, but also for games that do not include player matching or competition function. To this end, the UI broker server 10 may operate in conjunction with a UI broker module implemented in the game streaming server 20.

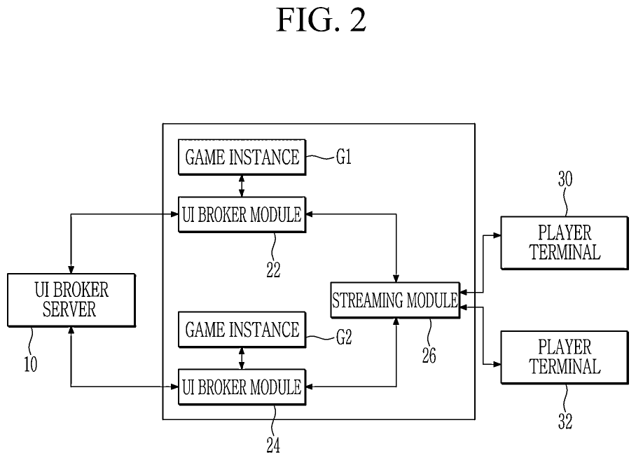

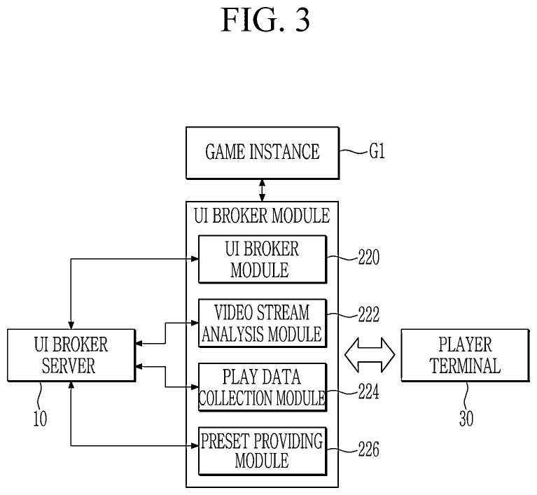

FIG. 2 is a block diagram for explaining a game streaming server according to an embodiment. FIG. 3 is a block diagram for explaining a UI broker module according to an embodiment.

Referring to FIG. 2, the game streaming server 20 according to an embodiment may include a plurality of UI broker modules 22 and 24 and a streaming module 26.

The UI broker modules 22 and 24 may control inputs of a player to game instances G1 and G2, analyze play content for the game instances G1 and G2, and interact with the player. The UI broker server 10 may provide wins and losses of the player based on analysis of the UI broker modules 22 and 24.

The streaming module 26 may stream the game instance G1 implemented by the UI broker module 22 and the UI broker server 10 to enable competition between players to the player terminal 30. In addition, the streaming module 26 may stream the game instance G2 implemented by the UI broker module 24 and the UI broker server 10 to enable competition between players to the player terminal 32.

Referring to FIG. 3 together, the UI broker module 22 may include a UI control module 220, a video stream analysis module 222, a play data collection module 224, and a preset providing module 226. Although FIG. 3 illustrates only the UI broker module 22, the content described in relation thereto may be equally applied to the UI broker module 24. That is, the UI broker module 24 may include a UI control module 240, a video stream analysis module 242, a play data collection module 244, and a preset providing module 246 to respectively correspond to those shown in FIG. 3.

The UI control module 220 may control a game progress by intervening in an input of a player (i.e., a first player), that is, a UI, for the game instance G1. For example, the UI control module 220 may intervene in the input of the player transmitted from the player terminal 30 to transmit the player input to the game instance G1 or control the game progress such as preparing a game, starting the game, ending the game, etc. regardless of an actual input of the player. In addition, the UI control module 220 may block the input of the player when necessary to control the game progress.

Specifically, the UI control module 220 may transmit a UI using a keyboard, mouse, gamepad, etc. for various operations during game, such as clicking a button on a game user interface screen, entering text, moving screen objects, etc., to the game instance G1. Meanwhile, the UI control module 220 may block a UI in order to control game progress of multiple players or to prevent problems that may affect fairness of game, such as hacking.

The UI control module 240 may control the game progress by intervening in an input of a player (a second player) for the game instance G2. In this regard, for a detailed operation, refer to the description of the UI control module 220.

The video stream analysis module 222 may analyze a video stream including play content, extract wins and losses decision data, and transmit the wins and losses decision data to the UI broker server 10. Here, the wins and losses decision data is data that may be used to decide wins and losses between players, and may include, for example, data such as scores, icons, and images recognized or extracted from the video stream. The UI broker server 10 may decide wins and losses of the player based on the wins and losses decision data received from the video stream analysis module 222 of the UI broker module 22, and provide the wins and losses as wins and losses data to the UI broker module 22. The video stream analysis module 242 may also perform the same or similar operations as the video stream analysis module 222.

For example, the video stream analysis module 222 may extract a score of “300” from a video stream including play content of the first player and transmit the score to the UI broker server 10 as the wins and losses decision data. Meanwhile, the video stream analysis module 242 may extract a score of “296” from a video stream including play content of the second player and transmit the score to the UI broker server 10 as the wins and losses decision data. The UI broker server 10 may decide that the first player wins and the second player loses according to the wins and losses decision data received from the video stream analysis modules 222 and 224, and provide again this to the UI broker modules 22 and 24 as wins and losses data. The UI broker modules 22 and 24 may interact with the first player and the second player, respectively, according to the wins and losses data received from the UI broker server 10. For example, the UI broker modules 22 and 24 may perform interaction by transmitting meaning that the first player wins and the second player loses to the players through the player terminals 30 and 32 by using various methods such as visual, auditory, tactile, etc.

In some embodiments, the video stream analysis modules 222 and 224 may interpret specific parts of a user screen transmitted as the video stream to make informatization of score, time, ranking, etc. For example, the video stream analysis modules 222 and 224 may interpret a part of a game streaming screen (e.g., a part showing the score, time, etc.), and analysis results may be used to decide wins and losses or priority of the game. To this end, an area analyzed may be a part of the game video stream or image information of a part of a game instance memory, and is not limited to a specific area. Based on such automation of the game progress and result information analysis, a fair decision of wins and losses may be possible.

To this end, an area analyzed may be a part of the game video stream or image information of a part of a game instance memory, and is not limited to a specific area.

The play data collection module 224 may collect play data of players. Here, the play data may mean inputs of players or raw data including play content. For example, the play data may include data that players input for a game progress, video clips recorded during play, screenshots recorded during play, log records, etc., and the collected data may be appropriately classified and managed (e.g. through tagging). Partitioning or indexing for high-speed processing may be performed on the collected and stored play data as needed.

The UI broker server 10 may generate a preset including information about a game configuration of the game instance G1 from the raw data collected by the play data collection module 224.

The preset may define analysis criteria required for analysis of the play data collected by the play data collection modules 224 and 244. For example, the preset may define that a game screen proceeds in the order of a start screen, a play screen, and a result screen according to a game state. As another example, the preset may define that the start screen is a screen including a red start button and an icon of a specific shape. In addition, the preset may include area information and color information for red recognition, area information and comparison text for OCR recognition, area information for icon recognition, information about comparison images and match ratios, etc. The other screens classified during the game progress may also be defined in the preset in the same way as above.

The UI broker server 10 may perform a simulation analysis based on the preset and verify the preset according to analysis results. Specifically, the UI broker server 10 may simulate a game on the basis of the preset based on the collected play data. The UI broker server 10 may compare simulation results with results of actually running the game to verify the appropriateness of analysis criteria of the preset. When the analysis criteria defined through the preset are not verified enough to analyze a game play in real time, the UI broker server 10 may repeat a process of correcting the preset.

The preset providing module 226 may store the preset that has been verified enough to analyze the game play in real time and provide the preset to the UI broker module 22. That is, when intervening in the game progress in real time, the UI broker module 22 may use the preset provided through the preset providing module 226.

Specifically, the UI broker module 22 may analyze a play state in real time by using the preset. For example, the UI broker module 22 may obtain a player input, video stream data, etc. of a game being played in real time. In some embodiments, a period for obtaining data may be designated according to game characteristics. As another example, the UI broker module 22 may analyze which stage a player is currently in the game flow by using the preset. As another example, the UI broker module 22 may select an appropriate preset for the game flow and perform analysis on the extracted data by using the selected preset. In some embodiments, when the game flow is not clearly recognized, analysis may be performed by using multiple presets. When analysis fails, the play data that was an analysis target may be separately stored and utilized to improve the preset.

The descriptions of the play data collection module 224 and the preset provision module 226 may be equally applied to the play data collection module 244 and the preset provision module 246.

In some embodiments, the game progress may be performed as follows. First, a matching start screen between players may be output, and a game instance may be executed. The UI broker module 22 may recognize that the matching start screen is a game start screen, and at this time, an event that activates a UI may be activated. In this case, a game start event may be transmitted to the UI broker server 10. Meanwhile, the UI broker module 22 may determine a game play screen and, at this time, intervene in and monitor a UI. Meanwhile, the UI broker module 22 may determine a game result screen and stop a UI. In this case, game result information and game end event may be transmitted to the UI broker server 10. Thereafter, the game instance may be stopped and a matching result screen may be output.

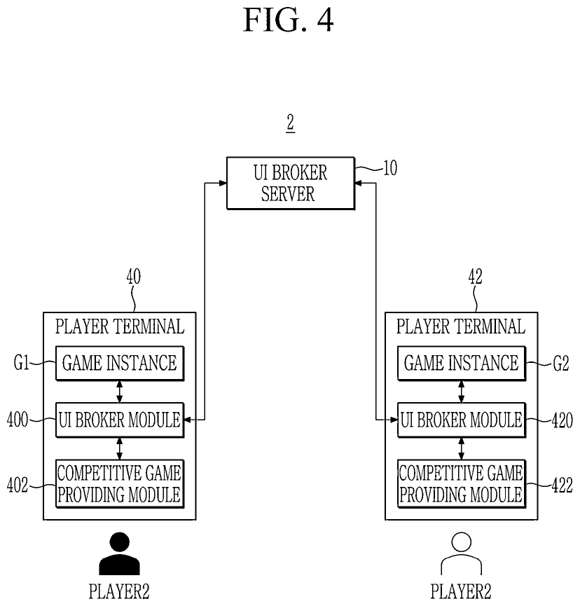

FIG. 4 is a block diagram for explaining a system for providing game wins and losses according to an embodiment.

Referring to FIG. 4, in a system 2 for providing game wins and losses according to an embodiment, UI broker modules 400 and 420 may be respectively included in player terminals 40 and 42. Unlike the system 1 for providing game wins and losses described above with reference to FIG. 1, a standalone game application is installed in each of the player terminals 40 and 42, and the game instances G1 and G2 may be created therefrom. The descriptions of the UI broker modules 22 and 24 described above with reference to FIG. 1 may be applied to the UI broker modules 400 and 420 provided in the player terminals 40 and 42, respectively.

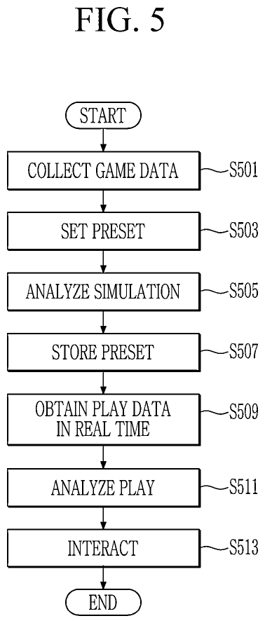

FIG. 5 is a flowchart for explaining a method for providing game wins and losses according to an embodiment.

Referring to FIG. 5, the method for providing game wins and losses according to an embodiment may include collecting raw data about an input of a player and play content (S501), generating a preset including information about a game configuration of a game instance from the raw data (S503), performing simulation analysis based on the preset and verifying the preset according to analysis results (S505), and storing the verified preset (S507).

In addition, the method for providing game wins and losses according to an embodiment may include obtaining play data including the input of the player and the play content for the game instance in real time (S509) and analyzing the play data in real time (S511).

Step S511 of analyzing the play data in real time may include extracting wins and losses decision data by analyzing the play data obtained in real-time and generating wins and losses data that decide wins and losses of the player based on the wins and losses decision data and the preset. In some embodiments, the step of extracting the wins and losses decision data may include extracting the wins and losses decision data by analyzing a video stream including the play content.

In addition, the method for providing game wins and losses according to an embodiment may include providing the wins and losses of the player based on the wins and losses data and interacting with the player (S513).

For more detailed information about the method for providing game wins and losses according to an embodiment, refer to the content described above in relation to FIGS. 1 to 4.

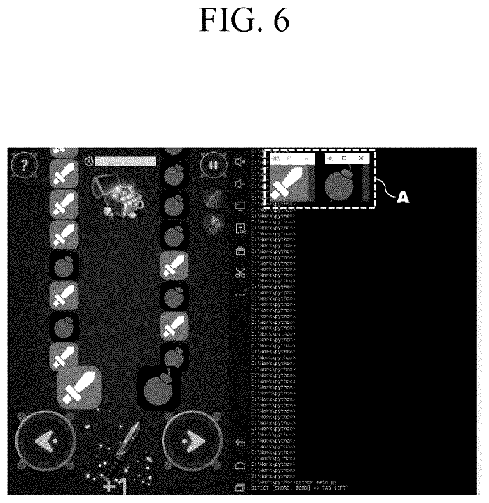

FIGS. 6 to 8 are diagrams showing implementation examples of a system for providing game wins and losses according to an embodiment.

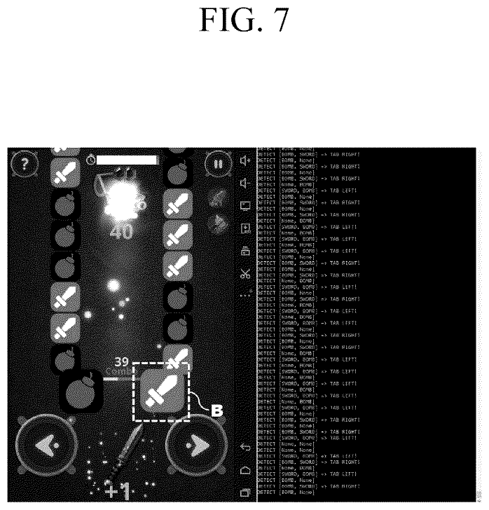

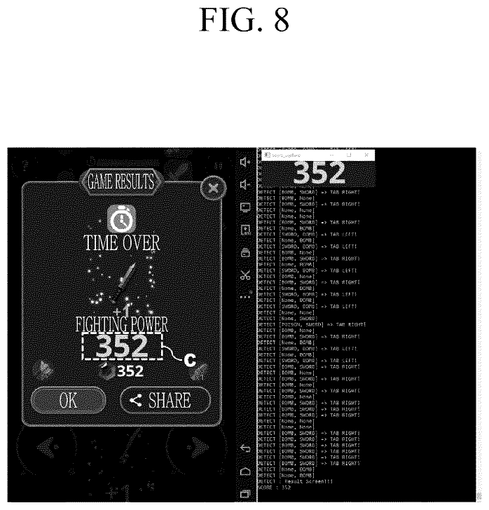

In FIG. 6, an area designated as ‘A’ shows a video stream analysis module analyzing a specific part on a user screen and identifying an icon on an example screen. An area designated as ‘B’ in FIG. 7 shows a UI control module moving a knife icon to the right on an example screen. An area designated as ‘C’ in FIG. 8 shows the video stream analysis module OCR-analyzing a part where score is displayed on an example screen.

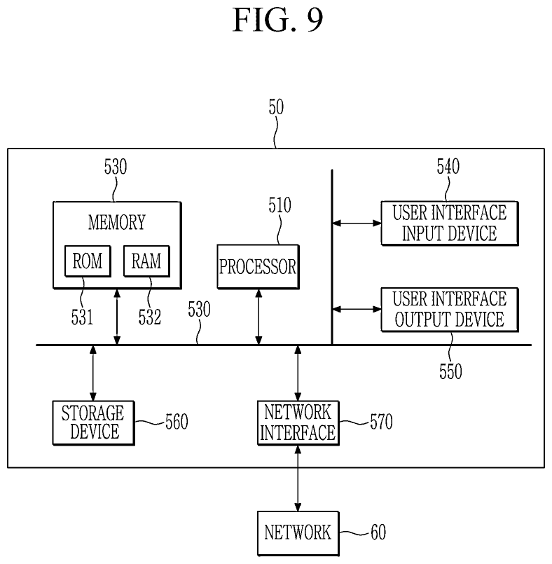

FIG. 9 is a block diagram illustrating a computing device for implementing a system and method for providing game wins and losses according to embodiments.

Referring to FIG. 9, the system and method for providing game wins and losses according to embodiments may be implemented by using a computing device (or computer) 50.

The computing device 50 may include at least one of a processor 510, a memory 530, a user interface input device 540, a user interface output device 550, and a storage device 560 that communicate via a bus 520. The computing device 50 may also include a network interface 570 that is electrically connected to a network 60, such as a wired or wireless network. The network interface 570 may transmit or receive signals to and from other devices over the network 60.

The processor 510 may be implemented in various types such as an Application Processor (AP), a Central Processing Unit (CPU), a Graphics Processing Unit (GPU), etc., and may be any semiconductor device that executes commands stored in the memory 530 or the storage device 560. The processor 510 may be configured to implement the functions and methods described with reference to FIGS. 1 to 8.

The memory 530 and the storage device 560 may include various types of volatile or non-volatile storage media. For example, the memory 530 may include read-only memory (ROM) 531 and random access memory (RAM) 532. In some embodiments, the memory 530 may be located inside or outside the processor 510, and the memory 530 may be connected to the processor 510 through various known means.

The system and method for providing game wins and losses according to some embodiments may be implemented with a program or software executed in the computing device 50, and the program or software may be stored in a computer-readable medium.

The system and method for providing game wins and losses according to some embodiments may be implemented with hardware that may be electrically connected to the computing device 50.

In some embodiments, at least some of the functions described above may be provided to developers through an SDK. Accordingly, developers may use the SDK to create game application builds.

According to the embodiments described above, by providing a game environment in which competitive play between users is possible even for games without a matching or competition function, a game immersion and interest of users playing games may be increased.

Although the embodiments of the present invention have been described in detail above, the scope of the present invention is not limited thereto, and various modifications and improvements made by those of ordinary skill in the field to which the present invention pertains also belong to the scope of the present invention.

1. A system for providing game wins and losses comprising:
a user input (UI) broker module configured to control an input of a player for a game instance, analyze play content for the game instance, and interacting with the player; and
a user input broker server configured to provide wins and losses of the player based on analysis of the UI broker module.

2. The system for providing game wins and losses of claim 1, wherein:
the UI broker module includes
a UI broker module configured to control a game progress by intervening in the input of the player.

3. The system for providing game wins and losses of claim 1, wherein:
the UI broker module includes
a video stream analysis module configured to extract wins and losses decision data by analyzing a video stream including the play content, and transmit the wins and losses decision data to the UI broker server.

4. The system for providing game wins and losses of claim 3, wherein:
the UI broker module is configured to
determine wins and losses of the player based on the wins and losses decision data received from the UI broker module and provide the wins and losses to the UI broker module as wins and losses data, and
the UI broker module is configured to perform interaction with the player based on the wins and losses data.

5. The system for providing game wins and losses of claim 1, wherein:
the UI broker module includes
a play data collection module configured to collect raw data about the input of the player and the play content.

6. The system for providing game wins and losses of claim 5, wherein:
the UI broker server is configured to
generate a preset including information about a game configuration of the game instance from the collected raw data.

7. The system for providing game wins and losses of claim 6, wherein:
the UI broker server is configured to
perform a simulation analysis based on the preset and verify the preset according to the analysis.

8. The system for providing game wins and losses of claim 6, wherein:
the UI broker module includes
a preset providing module configured to provide a preset including information about the game configuration of the game instance.

9. The system for providing game wins and losses of claim 1, further comprising:
a game streaming server configured to provide game streaming to a player terminal,
wherein the UI broker module is included in the game streaming server.

10. The system for providing game wins and losses of claim 1, further comprising:
a player terminal,
wherein the UI broker module is included in the player terminal.

11. A method for providing game wins and losses comprising:
generating a preset including information about a game configuration of a game instance;
obtaining play data including an input of a player and play content for the game instance in real time;
extracting wins and losses decision data by analyzing the play data obtained in real time;
generating wins and losses data that decides the wins and losses of the player based on the wins and losses decision data and the preset; and
providing the wins and losses of the player based on the wins and losses data and performing interaction with the player.

12. The method for providing game wins and losses of claim 11, wherein:
the extracting of the wins and losses decision data includes
extracting the wins and losses decision data by analyzing a video stream including the play content.

13. The method for providing game wins and losses of claim 11, wherein:
the generating of the preset includes
collecting raw data about the input of the player and the play content; and
generating the preset from the raw data.

14. The method for providing game wins and losses of claim 11, further comprising:
performing a simulation analysis based on the preset and verifying the preset according to the analysis.

15. A computer-readable medium recording a program on a computer for executing:
generating a preset including information about a game configuration of a game instance;
obtaining play data including an input of a player and play content for the game instance in real time;
extracting wins and losses decision data by analyzing the play data obtained in real time;
generating wins and losses data that decides the wins and losses of the player based on the wins and losses decision data and the preset; and
providing the wins and losses of the player based on the wins and losses data and performing interaction with the player.
